(19) United States
(12) Patent Application Publication
(10) Pub. No.: US 2021/0075237 A1
(43) Pub. Date: Mar. 11, 2021

(54) BATTERY CHARGING DEVICE

(71) Applicant: BRONINE CO., LTD., Seoul (KR)

(72) Inventor: Sun Hwi MYUNG, Seoul (KR)

(73) Assignee: BRONINE CO., LTD., Seoul (KR)

(21) Appl. No.: 16/950,148

(22) Filed: Nov. 17, 2020

Related U.S. Application Data
(63) Continuation-in-part of application No. PCT/KR2019/005957, filed on May 17, 2019.

(30) Foreign Application Priority Data
May 17, 2018 (KR) 10-2018-0056552

(51) Int. Cl. H02J 7/00

(52) U.S. Cl. CPC H02J 7/0045; H02J 7/0048

(57) ABSTRACT

A battery charging device comprises: a charger body, which has at least two charging grooves formed on one side of the upper surface thereof and a display arranged on the other side of the upper surface thereof to display a charged state, and is connected to an external power source to enable power supply; multiple charging kits, each of which detachably is coupled in each charging groove, has a mounting groove formed on one surface thereof to allow a battery to be detachably placed in the mounting groove, and charges the battery placed in the mounting groove when the kits have been coupled in the charging groove; and a controller, which is arranged in the charger body, determines a charge condition of the battery placed in the mounting groove, and performs a control such that power necessary for charging is supplied from the charger body to the battery.

### CROSS-REFERENCE TO RELATED APPLICATIONS

The present application is a continuation-in-part of International Patent Application No. PCT/KR2019/005957, filed on May 17, 2019, which is based upon and claims the benefit of priority to Korean Patent Application No. 10-2018-0056552 filed on May 17, 2018. The disclosures of the above-listed applications are hereby incorporated by reference herein in their entirety.

### BACKGROUND

Embodiments of the inventive concept described herein relate to a battery charging device for charging a battery used in an electronic product such as a digital camera.

Unless otherwise specified herein, contents described in this section are not prior art to claims of this application. In addition, although the claims are included in this section, the claims should not be recognized as a prior art.

Recently, as portable electronic products, such as digital cameras, smartphones, laptop computers, and tablet personal computer (PC), have been widely used, rechargeable batteries have been used as power supply devices for the operations thereof. The rechargeable batteries include lithium-ion (Li-ion) batteries and nickel-hydrogen (Ni-MH) batteries.

Such rechargeable batteries have various charge amounts in a single charging operation depending on the capacity of the battery. When the battery is discharged due to long outdoor activities, the electronic products cannot be used any more.

In this case, an extra battery, which is preliminary, has to be used or the battery has to be urgently charged in a rechargeable place for reusing, which makes a user inconvenient. In addition, when a user is going on a (business) trip, the user has to take a charger. If the user carries three electronic products such as a digital camera, a smartphone, a laptop computer, for example, the user has to inconveniently prepare three types of chargers. This is because the sizes of batteries and charging voltages are varied depending on electronic products or brands. As well, when the user has to prepare the extra battery, the user may additionally spend money for getting the battery.

### SUMMARY

Embodiments of the inventive concept provide a battery charging device capable of charging various portable electronic product batteries.

According to an exemplary embodiment, a battery charging device includes a charger main body including at least two charging grooves formed in one side of a top surface of the charger main body, and a display provided at an opposite side of the top surface to display a charging state such that power from an external power supply is supplied, a plurality of charging kits detachably coupled into the charging grooves, in which the charging kit includes a mounting groove formed in one surface of each charging kit to detachably mount a battery, is configured to charge the battery mounted in the mounting groove when coupled into the charging groove, and protrude upward from the charging groove, and a control unit provided inside the charger main body to determine a charging condition of the battery mounted in the mounting groove and is configured to perform a control such that power necessary for charging is supplied from the charger main body to the battery. The charging grooves are divided into a left groove and a right groove about a central partition in the charger main body, and an outer portion of the charging groove is formed to be open such that a portion of the charging kit having larger than the charging groove protrudes out of the charger main body. The charging grooves are formed in equal size, a first charging terminal is provided inside each charging groove, and mounting grooves of the plurality of charging kits are formed in mutually different shapes such that mutually different types of batteries are selectively mounted.

According to another exemplary embodiment, a battery charging device includes a charger main body including a display to display a charging state and at least two first charging terminals provided on an outer wall of the charger main body, and connected with an external power supply to supply power, a plurality of charging kits including second charging terminals electrically connected with the first charging terminals. The second charging terminal is detachably coupled to the first charging terminal through magnetic force, and a mounting groove is formed in one surface of each charging kit to mount a battery. The battery mounted in the mounting groove is charged when the first charging terminal of the charger main body is electrically connected with the second charging terminal, and a control unit provided inside the charger main body to determine a charging condition of the battery mounted in the mounting groove and is configured to perform a control such that power necessary for charging is supplied from the charger main body to the battery. The mounting grooves of the plurality of charging kits are formed in mutually different shapes such that mutually different types of batteries are selectively mounted.

As described above, according to the battery charging device, various charging kits to mount various types of batteries are provided in one charger main body. Accordingly, various types of batteries may be charged using one battery charging device.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a perspective view of a battery charging device, according to an embodiment of the inventive concept;

FIG. 2 is an exploded perspective view of FIG. 1;

FIG. 3 is another exploded perspective view of FIG. 1;

FIG. 4 is a view illustrating a use state; and

FIG. 5 is a perspective view of a battery charging device, according to another embodiment of the inventive concept.

### DETAILED DESCRIPTION

Advantage points and features of the disclosure and a method of accomplishing the same will become apparent from the following description made with reference to accompanying drawings. However, the disclosure may be embodied in various different forms, and should not be construed as being limited only to the illustrated embodiments. Rather, these embodiments are provided as examples so that this disclosure will be thorough and complete, and will fully convey the concept of the inventive concept to those skilled in the art. The inventive concept may be defined by scope of the claims. The same reference numerals refer to the same components throughout the whole specification

In addition, in the following description of the disclosure, a detailed description of well-known art or functions will be ruled out in order not to unnecessarily obscure the subject matter of the disclosure. In addition, the following terminology is defined based on a function of an embodiment of the disclosure and varied depending on the intent of an operator or a custom. Accordingly, the definition should be made based on contents throughout the specification.

Before description, according to various embodiments, the same reference numeral will be assigned to the same component, and the first embodiment will be representatively described. According to another embodiment, the following description will be made while focusing on the difference between an embodiment and other embodiments.

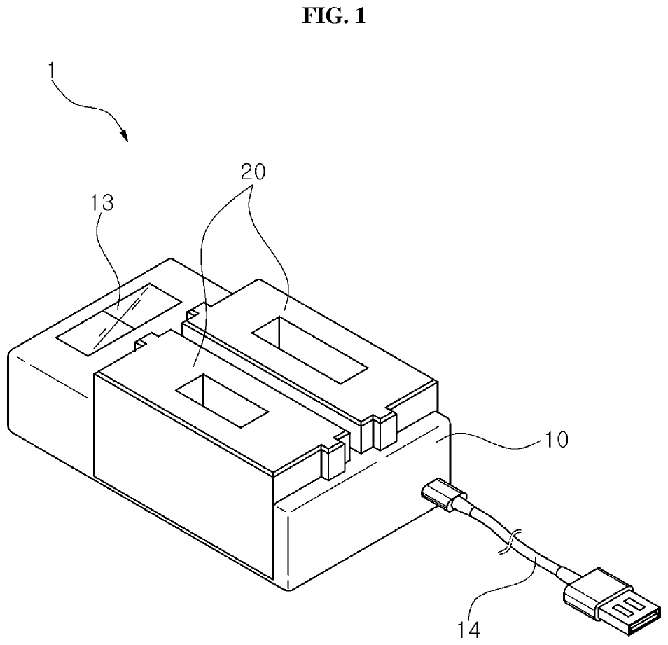

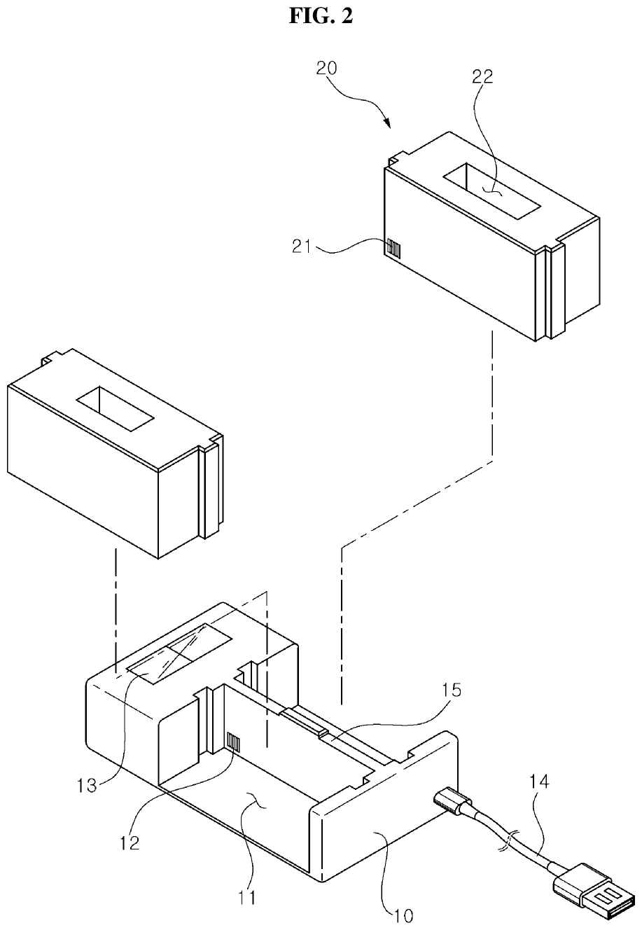

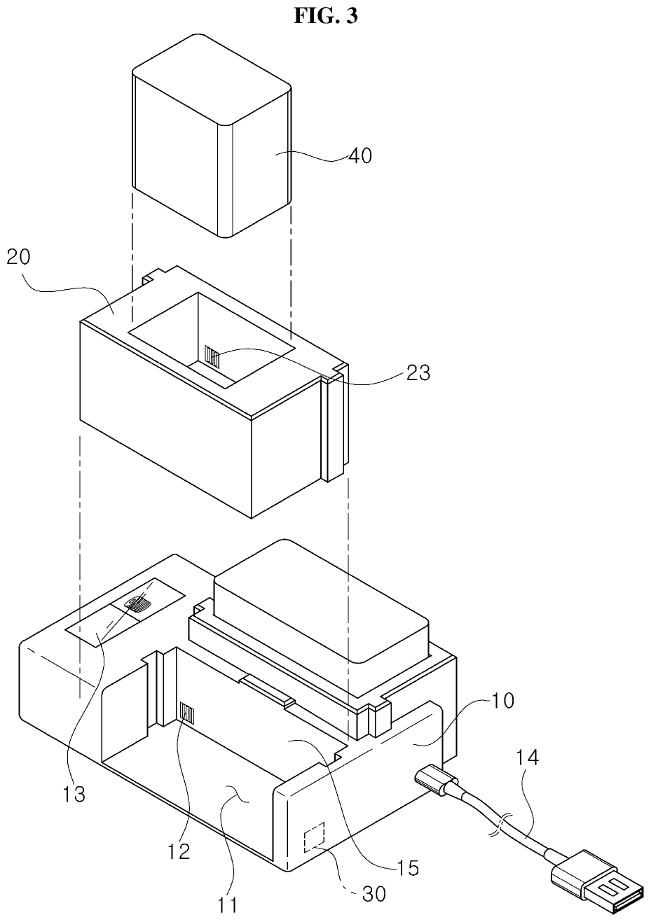

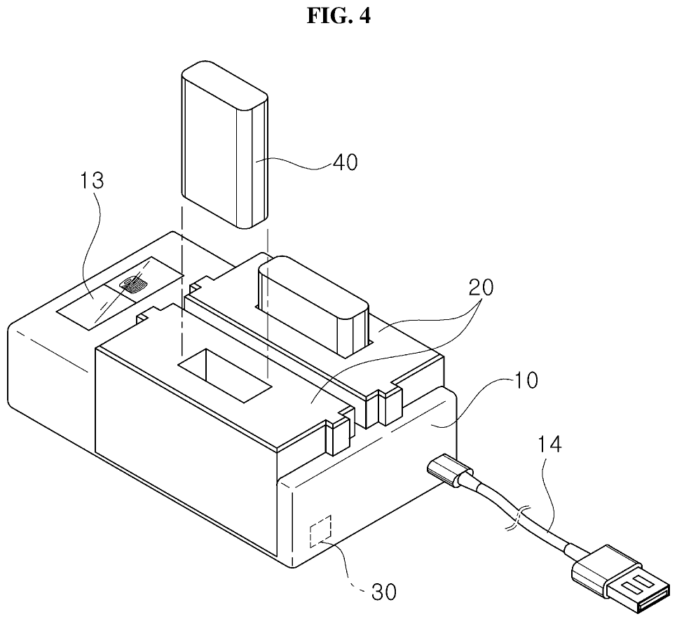

FIGS. 1 to 4 illustrate an embodiment of the inventive concept. FIG. 1 is a perspective view, FIGS. 2 and 3 are exploded perspective views, and FIG. 4 is a view illustrating a use state.

Hereinafter, components of a battery charging device 1 according to an embodiment of the inventive concept and the connection relationship between the components will be described in detail with reference to FIGS. 1 to 3.

Referring to FIG. 1, a charger main body 10 is provided. The charger main body 10 is to operatively install components which are to be described below. Such the charger main body 10 includes at least two charging grooves 11 formed in one side of a top surface thereof and laterally symmetrical to each other, and a liquid crystal display 13 as an exemplary embodiment of a display provided at an opposite side of the top surface thereof to display a charging state. In addition, the charger main body 10 is connected with an external power supply through a power cable 14 such that power is supplied. In this case, one end portion of the power cable 14 is coupled to the charger main body 10, and an opposite end portion of the power cable 14 is provided in the form of a USB connector to be connected with a personal computer (PC) or a laptop computer. In addition, an adaptor may be coupled to the USB connector to be connected with an outlet, and coupled to an outlet of 220V. The voltage may be supplied such that two batteries 40 are charged through the power cable 14, and a charging voltage may be selectively supplied to be matched to a proper voltage of the battery based on the analysis result of the algorithm of the battery.

The charger main body 10 may be formed in a hexahedral shape, and may have various sizes depending on the number of the charging kits 20 to be described below. A circuit board (not illustrated) necessary for power supplying, charging, and driving of the liquid crystal display 13 may be operatively provided in the charger main body 10. The liquid crystal display 13 described above may display a charging state and a charging time for each charging kit 20, and an alarm may be additionally provided when power is fully charged.

The above-described charging grooves 11 are formed in equal sizes, and first charging terminals 12 are provided in the charging grooves 11. The first charging terminal 12 may be electrically connected with a second charging terminal 21 of the charging kit 20.

The charging grooves 11 is divided into a left groove and a right groove about a central partition 15 in the charger main body 10 described above, and an outer portion of the charging groove 11 is formed to be open. This is because a larger size of charging kit 20, which is to be described below, may partially protrude outward as illustrated in FIG. 3.

Next, referring to FIG. 2, the charging kit 20 is coupled into the above-described charging groove 11. The charging kit 20 is coupled into the charging groove 11 of the charger main body 10 in the state that one of various types of batteries 40 is mounted, such that the battery 40 is charged. To this end, the above-described charging kit 20 is detachably coupled into the charging groove 11, and a mounting groove 22 is formed in the surface of the charging kit 20 such that the battery 40 is detachably mounted in the mounting groove 22.

In this case, mounting grooves 22 of a plurality of charging kits 20 may have mutually different shapes such that mutually different types of batteries 40 are selectively mounted. For example, the mounting groove 22 of a certain charging kit 20 is formed in the shape of allowing mounting of a battery 40 for a camera from company ‘C’, and the mounting groove 22 of another charging kit 20 is formed in the shape of allowing mounting of a battery 40 for a digital camera from company ‘N’. Accordingly, the user may easily charge various types of batteries 40 with a plurality of charging kits 20 which are provided in one charger main body 10 and have mounting grooves 22.

In addition, the charging kit 20 described above is provided in one side of an outer surface thereof with the second charging terminal 21 electrically connected with the first charging terminal 12, which is coupled to the charging groove 11. In addition, a third charging terminal 23 is provided in the mounting groove 22 to be electrically connected with the battery 40 when the battery 40 is mounted. The position and the size of the third charging terminal 23 may be changed depending on the type of the battery 40 coupled into the mounting groove 22.

In addition, the above-described charging kit 20 may be formed in size to be received in the charging groove 11 as illustrated in FIGS. 1 and 2, and formed to partially protrude outward as illustrated in FIG. 3. In addition, when the size of the battery 40 is smaller, the charging kit 20 to be fully received in the charging groove 11 is used. When the size of the battery 40 is larger, the charging kit 20 partially protruding out of the charging groove 11 is used.

Meanwhile, the above-described charger main body 10 includes a control unit 30. The control unit 30 may determine a charging condition of the battery 40 mounted in the mounting groove 22 such that power necessary for charging is supplied from the charger main body 10.

In other words, the control unit 30 senses the coupling when the charging kit 20, in which the battery 40 is mounted, is coupled into the charging groove 11 of the charger main body 10, allows a fine current to flow out to analyze the type of the relevant battery 40, and supplies a charging voltage corresponding to the analysis when the analysis is finished, thereby charging the battery 40. The control unit 30 is electrically connected to the above-described circuit board (not illustrated).

Hereinafter, the overall usage of the battery charging device 1 according to an embodiment disclosed herein will be described with reference to FIG. 4 in detail.

As the power cable 14 of the charger main body 10 is connected with the external power supply, power may be supplied from the external power supply. The charging kit 20 matched to the type of the battery 40 which needs to be charged is prepared, and the battery 40 is coupled into the mounting groove 22 of the charging kit 20. In this case, the battery 40 is connected with the third charging terminal 23 in the mounting groove 22.

Then, the charging kit 20 is coupled into the charging groove 11 of the charger main body 10. In this case, the second charging terminal 21 provided in an outer portion of the charging kit 20 is electrically connected with the first charging terminal 12 in the charging groove 11.

When the coupling is completed, the type of the relevant battery 40 is analyzed by the control unit 30. When the analysis is terminated, the charging of the battery 40 is started by a charging voltage matched to the analysis. The charging state is displayed through the liquid crystal display 13 during the charging. When the charging is completed, the charging terminated is notified using an alarm.

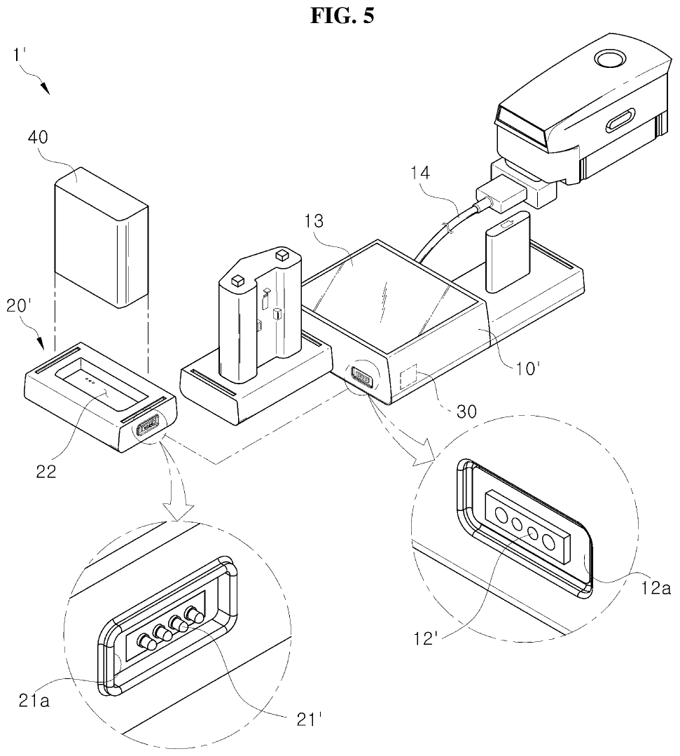

FIG. 5 illustrates a battery charging device, according to another embodiment of the inventive concept.

A battery charging device 1′ according to another embodiment of the inventive concept has a structure in which the charging kit 20 is mounted on an outer wall of a charger main body 10′ formed in a hexahedral shape, which is different from that of the previous embodiment.

Similarly to the battery charging device 1 according to an embodiment of the inventive concept, the charger main body 10′ includes the liquid crystal display 13 to display a charging state, and at least two first charging terminal 12′ provided on the outer wall, such that power is supplied from the external power supply.

At least two first charging terminals 12′ electrically connected with second charging terminals 21′ of the charging kits 20 are provided on an outer wall of the charger main body 10′.

The first charging terminals 12′ provided on one outer wall of the charger main body 10′ are arranged to be spaced apart from each other, thereby preventing the charging kits 20′, which are coupled to the first charging terminals 12′, from mutually interfering with each other.

In addition, a metal member 12a is provided inside the first charging terminal 12′ and a magnetic substance 21a is provided in the second charging terminal 21′ which is to generate magnetic force and coupled to the metal member 12a of the first charging terminal 12′.

Although the present embodiment has been described herein in that a plurality of first charging terminals 12′ is provided on the outer wall of the charger main body 10′, the inventive concept is not limited thereto. At least one first charging terminal 12′ may be provided.

Accordingly, when the second charging terminal 21′ of the charging kit 20, in which the battery 40 is mounted, is coupled to the first charging terminal 12′ of the charger main body 10′, the charging kit 20′ is mounted on the charger main body 10′ through the magnetic force between the metal member 12a of the first charging terminal 12′ and the magnetic substance 21a of the second charging terminal 21′.

Meanwhile, the metal member 12a of the first charging terminal 12′ is formed to be recessed inward from the outer wall, and at least a portion of a circumference of the second charging terminal 21′ is formed to at least partially protrude.

Accordingly, when the second charging terminal 21′ is attached to the first charging terminal 12′ through the magnetic force, at least a portion, which protrudes, of the circumference of the second charging terminal 21′ is introduced into the metal member 12a which is recessed inward from the outer wall. In other words, the at least a portion, which protrudes, of the circumference of the second charging terminal 21′ is introduced and fitted into the recess inward from the outer wall of the charger main body 10′. To this end, the at least a portion of the circumference of the second charging terminal 21′ may have the shape fixedly inserted into the recess inward from the outer wall of the charger main body 10′.

Accordingly, when the second charging terminal 21′ is attached to the first charging terminal 12′ through the magnetic force, the at least a portion, which protrudes, of the circumference of the second charging terminal 21′ is inserted into the recess inward from the outer wall of the charger main body 10′, such that the first charging terminal 12′ and the second charging terminal 21′ may be attached to each other at a right position. In addition, accordingly, even if external impact is applied to the charger main body 10′, the first charging terminal 12′ and the second charging terminal 21′ may be easily maintained attached to each other through the magnetic force.

In addition, the first charging terminal 12′ of the charger main body 10′ is electrically connected with the second charging terminal ‘21’ of the charging kit 20′.

In this case, although the present embodiment has been described in that the metal member 12a of the first charging terminal 12′ and the magnetic substance 21a of the second charging terminal 21′ are detachably coupled to each other through magnetic force, the present disclosure is not limited thereto. For example, the magnetic-force coupling manner may be substituted with various coupling manners such as a press-fitting manner or a male and female coupling manner.

Although the disclosure is not provided for illustrative purpose, those skilled in the art will make various modifications without departing from the subject matters of claims. Accordingly, the protection range of the right of the disclosure is not limited to the above-described specific embodiments.

As described above, according to the battery charging device, multiple charging kits may be provided to mount various types of batteries in one main charger body. Accordingly, various types of batteries may be charged using one battery charging device.

The disclosure is applicable to the fields of a battery charging device to charge batteries of various electrical and electronic products.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A battery charging device comprising:
a charger main body including at least two charging grooves formed in one side of a top surface of the charger main body, and a display provided at an opposite side of the top surface to display a charging state such that power from an external power supply is supplied;
a plurality of charging kits detachably coupled into the charging grooves, wherein each charging kit includes a mounting groove formed in one surface of the charging kit to detachably mount a battery, is configured to charge the battery mounted in the mounting groove when coupled into the charging groove, and protrudes upward from the charging groove; and
a control unit provided inside the charger main body to determine a charging condition of the battery mounted in the mounting groove and is configured to perform a control such that power necessary for charging is supplied from the charger main body to the battery,
wherein the charging grooves are divided into a left groove and a right groove about a central partition in the charger main body, and an outer portion of the charging groove is formed to be open such that a portion of the charging kit having larger than the charging groove protrudes out of the charger main body, and
wherein the charging grooves are formed in equal size, a first charging terminal is provided inside each charging groove, and mounting grooves of the plurality of charging kits are formed in mutually different shapes such that mutually different types of batteries are selectively mounted.

2. The battery charging device of claim 1, wherein the charging kit includes:
a second charging terminal provided on one outer surface of the charging kit and electrically connected with the first charging terminal when coupled into the charging groove.

3. The battery charging device of claim 2, further comprising:
a third charging terminal to be electrically connected with the battery when the battery is mounted inside the mounting groove.

4. A battery charging device comprising:
a charger main body including a display to display a charging state and at least two first charging terminals provided on an outer wall of the charger main body, and connected with an external power supply to supply power;
a plurality of charging kits including:
second charging terminals electrically connected with the first charging terminals, wherein the second charging terminal is detachably coupled to the first charging terminal through magnetic force; and
mounting grooves, wherein the mounting groove is formed in one surface of each charging kit to mount a battery, and the battery mounted in the mounting groove is charged when the first charging terminal of the charger main body is electrically connected with the second charging terminal; and
a control unit provided inside the charger main body to determine a charging condition of the battery mounted in the mounting groove and is configured to perform a control such that power necessary for charging is supplied from the charger main body to the battery,
wherein the mounting grooves of the plurality of charging kits are formed in mutually different shapes such that mutually different types of batteries are selectively mounted.

5. The battery charging device of claim 4, wherein the first charging terminal includes a metal member, and
wherein the second charging terminal includes a magnetic substance coupled to the metal member of the first charging terminal to generate magnetic force.

6. The battery charging device of claim 5, wherein the metal member of the first charging terminal is recessed inward from the outer wall,
wherein at least a portion of a circumference of the second charging terminal protrudes, and
wherein the at least a portion, which protrudes, of the circumference of the charging terminal is introduced into the metal member recessed inward from the outer wall, when the second charging terminal is coupled to the first charging terminal through the magnetic force.
